(19) United States
(12) Patent Application Publication
(10) Pub. No.: US 2023/0418850 A1
(43) Pub. Date: Dec. 28, 2023

(54) ITERATIVE SEARCH SYSTEM

(71) Applicant: Quantum Blue, Inc., Chicago, IL (US)

(72) Inventors: David L. Newman, Evanston, IL (US); Reginald A. Holmes, Pasadena, CA (US); Kenji Toyooka, Ottawa (CA)

(21) Appl. No.: 18/213,621

(22) Filed: Jun. 23, 2023

Related U.S. Application Data
(60) Provisional application No. 63/355,600, filed on Jun. 25, 2022.

(51) Int. Cl. G06F 16/332; G06F 40/242; G06F 40/166; G06F 40/247

(52) U.S. Cl. CPC G06F 16/3325; G06F 40/242; G06F 40/166; G06F 40/247

(57) ABSTRACT

A system for conducting a search of a database comprising the steps of a user entering a first search term to the program, dissecting by the program, the first search term into its component parts using a dictionary algorithm; searching a first database using the first search term and saving a first result; the user modifying the first result to form a second search term wherein the second search term includes at least one synonym from the first search term and conducting a second search using the second search term.

### CROSS-REFERENCE TO RELATED APPLICATION

This application claims priority to Provisional Application No. 63/355,600 filed Jun. 25, 2022.

### BACKGROUND

The present application pertains to software and systems for conducting an iterative search and where at least two databases are searched simultaneously by entering a single search term. Subsequent to entering the search term, modifications for the first database are made and search term variation 1 (STV1) is searched in database 1. Simultaneously STV2 is created and searched in database 2. Following the returning of the search results from STV1 and STV2, the system uses an algorithm to create alternate search results. Each search result may be further modified to provide for additional search parameters and variations that are iterative from STV1 to STV2.

Some examples of what users will be able to do with the present invention:

Find synonyms, antonyms, related words, rhymes, slang, trigger words and common follow-up words to any word or phrase.

Retrieve definitions, examples, etymologies and frequency tables for any word or phrase.

Search existing trademarks and domains that contain any word or phrase.

Invent new words, business names, generate potential tag lines, and proper names using combinations of words.

See suggestions for logo designs, colour schemes/palettes, font types and other branding ideas generated by the AI based on a user's history.

Create custom queries and combinations of term manipulations to further expand the repertoire offered by the Query Engine.

Using any of the content generated by the present invention, users can then:
1. Save their work in their online account so that they can resume at any point;
2. Apply for a trademark (for any term deemed potentially available);
3. Offer other services that can be subsequently modularly added, like logo design, branding consultations, graphic design, web design, trademark consultations, etc.

Other potential features include:
1. Notification system for account owners to inform them of searches/uses of specific terms.
2. AI assistant system that provides suggestions during the development of a project.
3. All text content generated by the present invention can be easily manipulated by the user with a lightweight drag and drop UI system that exists on top of the website HTML/CSS. This allows for rapid editing, moving, copying and deleting of words and phrases, and organizing texts into custom bins/paragraphs. This system makes it very easy for users to select parts of text to use or generate further content.

Query Engine: At the core of present invention is an assembly of various APIs, AI interfaces and databases to help generate content. These typically take inputs of words or phrases and then generate relevant results. The modular aspect of the system allows for the results from different engines to be combined and re-inputted into another engine, thus allowing for extensive natural language manipulation of words.

Additionally, custom engines can be created by the user by changing an AI query itself, using the word manipulation UI. This will allow users to develop a library of their own query engines.

### EXAMPLES

For example, given the following query engines:
(Find trademarks)—find trademarks that contain a term.
(Similar words)—find synonyms, slang, and examples of a word, phenome or phrase.
(Invent a word)—take two or more words and combine them to create a new invented word.

A user can then create a custom query that combines all three in a specific order, so that with one click they can find, using the term “BLUE” for example:
BLUE->(Find trademarks)->QUANTUM BLUE->(Similar words)->ELECTROMAGNETIC AZURE->(Invent a word)->ELECTROZURE

Furthermore, they could create a custom AI Query using the word manipulation system, such as:
“What is a word prefix that denotes the same meaning as [TERM]?”
Which they could then use like any other query, and in combination with other queries:
WATER->(custom query)->HYDRO->(Find trademarks)->HYDROPONICS LTD.

### SUMMARY

The present invention includes a system for conducting a search of a database comprising the steps of a user entering a first search term to the program, dissecting by the program, the first search term into its component parts using a dictionary algorithm; searching a first database using the first search term and saving a first result; the user modifying the first result to form a second search term wherein the second search term includes at least one synonym from the first search term; conducting a second search using the second search term. The system wherein the program includes a user modification interface to provide an iterative variation selection process. The system wherein the user modification interface includes one of a replacement module, a re-arrangement module, an edit module and a deletion module for modification of the first result. The system further comprising the step of using a thesaurus program to promulgate variations and ranking the variations. The system wherein promulgation of variations is undertaken using Artificial Intelligence (AI). The system wherein the AI is a ChatGPT program.

### BRIEF DESCRIPTION OF DRAWINGS

FIG. 1a is a flow diagram of Search Term Variations 1 and 2;

FIG. 1b is a flow diagram of Search Term Variation Words 1 and 2;

FIG. 2 is an example if a Search Results Page/Dashboard;

FIG. 3 is a further example of a Search Results Page; and

FIG. 4 is a flow diagram of Modification Interface.

### DETAILED DESCRIPTION

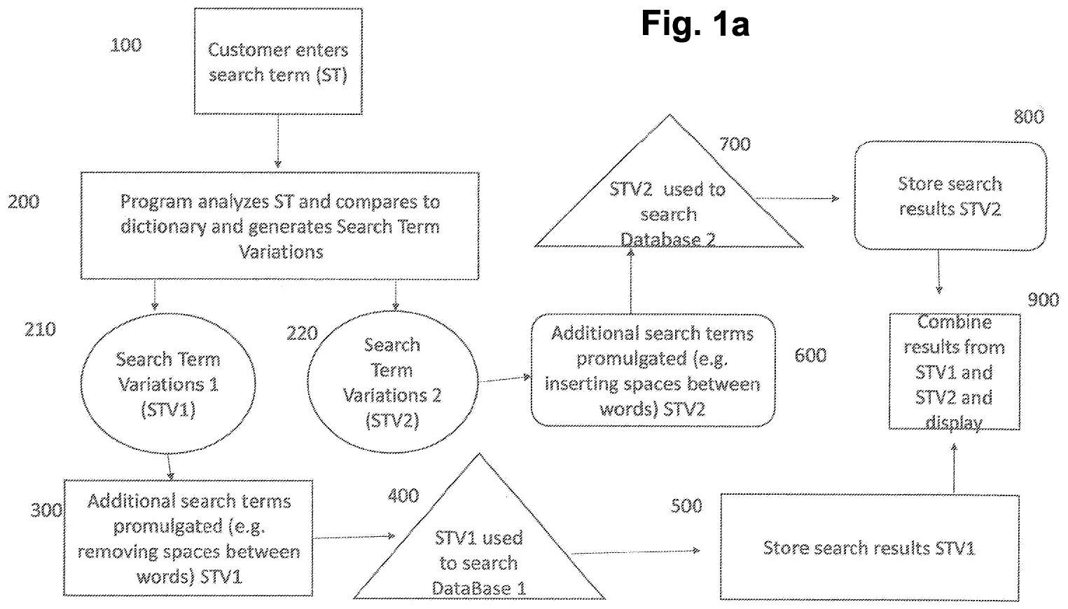

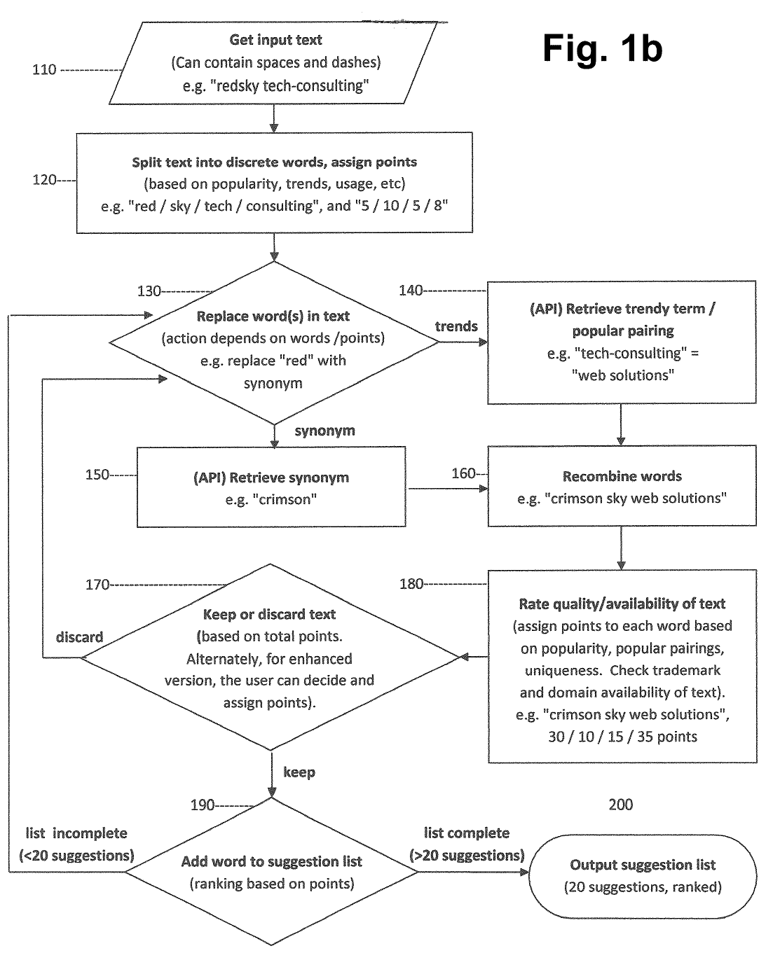

Turning to FIG. 1a, a flow diagram depicts an embodiment of the invention. A system for conducting a search of dual databases comprises the step 100 of entering the search term (ST) to the program (e.g. API, software, network or computer system). At step 200, the ST is dissected and analyzed in preparation to submitting to Database 1. For example, the search term (ST) may need to be modified to comport with the input parameters of Database 1. In an embodiment, the ST is separated into its component parts using a dictionary algorithm to form search term variation 1 (STV1) at step 210. At step 300, forming a first search term without spaces in STV1 is promulgated. Simultaneously at step 220, search term variation 2 (STV2) IS formed and at step 600 a second search term with spaces is formed STV2. It is to be understood that a search term my be alphanumeric, all numerals, all letters or a combination of both and using dashes, @, #, &, *, / or any other symbol or punctuation.

In an embodiment, if the user types in the search term with spaces between syllables, the default is for the program to automatically remove the spaces for a domain name search and to do a trademark search with spaces. In an embodiment the domain name search will include: .com, .net, .biz, .edu, .gov, .org and others.

For STV1 at step 400, the first search term is used to search a first database and at step 500 saving a first result for STV1 is stored. At the same time for STV2, using the second search term at step 700 database 2 is searched and at step 800 a second result based on STV2 is stored. Finally, at step 900 the two search results for STV1 and STV2 are displayed in combination on a single display. It is to be understood that the present invention may be applied for any number of search terms greater than two, so that STV3, STV4, STVn are to be modified and displayed in coordination with searches of databases 3, 4, n.

In an embodiment, Database 1 (400) may be a domain name database for assigning URLs to individuals or companies to use as a web address. In an embodiment, Database 2 (700) may be a trademark database for a government of a country where registered trademarks are stored. In an embodiment, Database 1 and 2 are searched simultaneously to determine whether a search term (e.g. brand name) is available both as a domain name and a trademark for usage by a new business or new product offering.

Turning to FIG. 1b, additional details of the searching and variations of the search term are described. The program receives a search request with multiple words 110. For example, the search term may have spaces, dashes and multiple words: “red” “sky” “tech-consulting.” At step 120 the text is split into discrete words and assigned points (e.g. based on popularity, trends, usage etc.). For example, “red”=5, “sky”=10, “tech”=5, “consulting”=8. Then at step 130 words in the search term are replaced depending on the words or points (e.g. “red” is replaced by taking first term and run thru database of synonyms) at step 150. For example use www.thesaurus.com (thesaurus API) to generate new search word: “crimson.” Or an API can be used to determine ranking of synonyms by determining popularity of a term at step 140. For example, use www.trends.google.com/searchterm_ (Google Trends) to substitute “web solutions” for “tech-consulting”. At step 160 the words are recombined to make a new search term alternative: “crimson sky web solutions.” At step 180 a rating of the quality or availability of the search term text is made. For example, the program may assign points to each word based on popularity, popular pairings or uniqueness. At step 170 by ranking and assigning points the search term can be assigned a level of interest and a “keep” or “discard” decision made accordingly. For example, by taking the top 5 words to make new search term and running through domain name Database 1 and then trademark Database 2 to check availability. Then repeat for all 5 words/terms to obtain “crimson”=30, “sky”=10, “web”=15 and “solutions”=35 a user may discard the search term and return to step 130, or keep the search term and progress to stop 190. At step 190 the search term is added to suggestion/alternatives list of variations from the original search term. The process is repeated until a satisfactory number of alternative suggestions is listed (e.g. 20). Finally at step 195, the list of 20 alternatives is output as a suggestion list. In an embodiment the list by be ordered or ranked using the points assigned previously in step 180. If the list of suggestions has less than 20 on the list then the program returns to step 130 to generate more alternative search terms (e.g. substituting “scarlet” for “crimson”).

The invention may be used to find, in an embodiment, a brand name to be used for both a domain name and a trademark. Upon typing in the proposed search term in a search bar, and selecting enter, the search term is analyzed using a search term generator/dictionary function to develop alternate/variations in search terms. In addition to the above algorithm steps, the following may be undertaken with each search term: may be split-up with spaces in between each syllable, have the following added at the end of the word: “S,” “ES,” “ED,” “ING,” “IES” and at the beginning of the word: “GO” and “YOUR”. Each of these variations may be looked up in a dictionary to see if the new word is present. If so, then each of the variations is searched in the domain name/ICANN database and a trademark database.

In the above embodiment, steps 120 thru 190 are automated and the program can make decisions based on ranking/points assigned to each new word or search term. In an alternate embodiment, some of the steps 120 thru 190 will require user input to select the next word/search term to be analyzed. Such an iterative search that takes user input at various steps will result in a highly customized and unique search term result. Through interaction between the program and the user, a highly customized process is enabled where the user feels part of the creation of new search terms to invent new search terms/brand names. For example, at step 150, the user may select a synonym from a list of synonyms to create a new search term. That new word is combined with other text to generate a new search term. In another embodiment, step 170 may be a place for user input to decide whether to “keep” or “discard” the text for the search term in order to establish a user directed, iterative search term selection process.

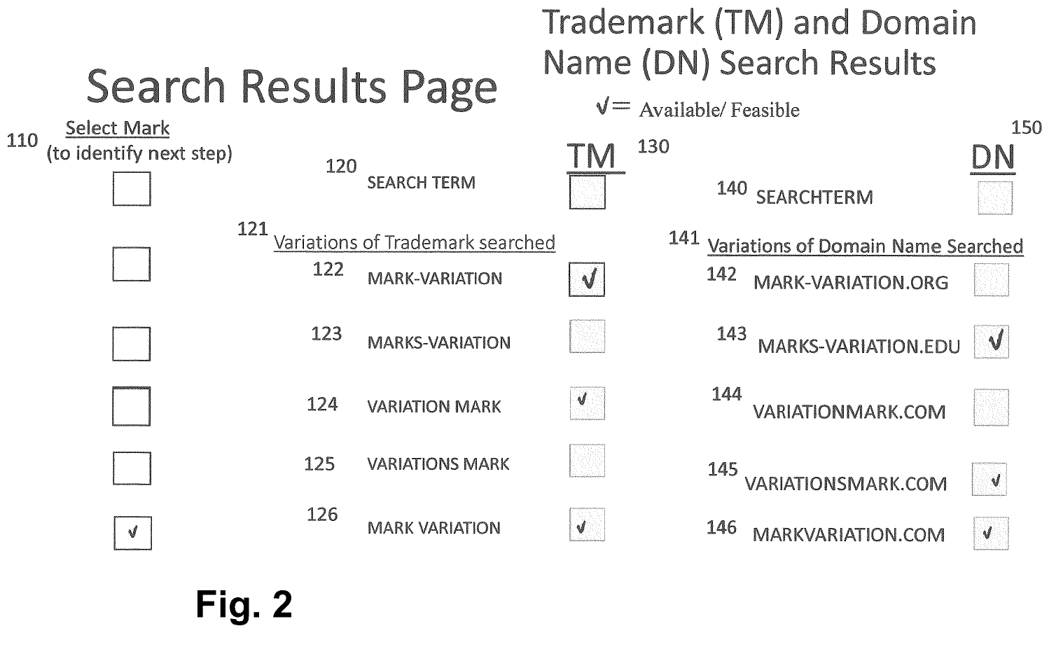

Turning to FIG. 2, a sample Search Results Page/dashboard is depicted. In the embodiment depicted for conducting a dual search the example provided is for searching domain names (DN) and trademarks (TM). In this embodiment, Database 1 is the ICANN domain name database and Database 2 is the USPTO trademark electronic application system (TEAS). As shown “search term” 120 has a space inserted when searching the TM database and “searchterm” 140 has the space omitted to search the DN database. As a result of the dual search being conducted the checkbox under TM 130 is unchecked and the checkbox under DN 150 is unchecked. So the display indicates that both the trademark and domain name are unavailable for the particular search term that was searched. As shown in FIG. 2, if there are no hits (no equivalent trademarks or domain names) then the program provides variations on the entered search term and a check mark is ticked for each variation of the search term/mark searched. Upon conducting a dual search, if there are no “hits” than a search term may be listed as “available” or “feasible” in Database 1 or 2, or both.

As discussed above, search term variations may be automatically generated or generated through an interactive process, but in either case the variations may be searched through the trademark database 121 and domain name database 141. The trademark variations search 121 is undertaken using the following search terms: “mark-variation” 122, “marks-variation” 123, “variation mark” 124, “variations mark” 125 and “mark variation”. After conducting the trademark search 121, the results are a finding of “availability” or “feasible” for “mark-variation” 122, “variation mark” 124 and “mark variation” 126. (It is understood that for a complete trademark to be cleared for “availability” the goods and services and other factors must be considered).

The domain name variations search 141 is undertaken using the following search terms: “marks-variations.org” 142, “marks-variation.edu” 143, “variationmark.com” 144, “variationsmark.com” 145 and “markvariation.com” 146. After conducting a search of the DN database the results are “availability” for “marks-variation.edu” 143, “variationsmark.com” 145 and “markvariation.com” 146.

So the user may select a variation term by checking a checkbox from column 110 in order to move to the next step (e.g. purchase a domain name or trademark). In the example provided, the last check box 110 is selected since the search term “mark variation” 126 and “markvariation.com” 146 is available.

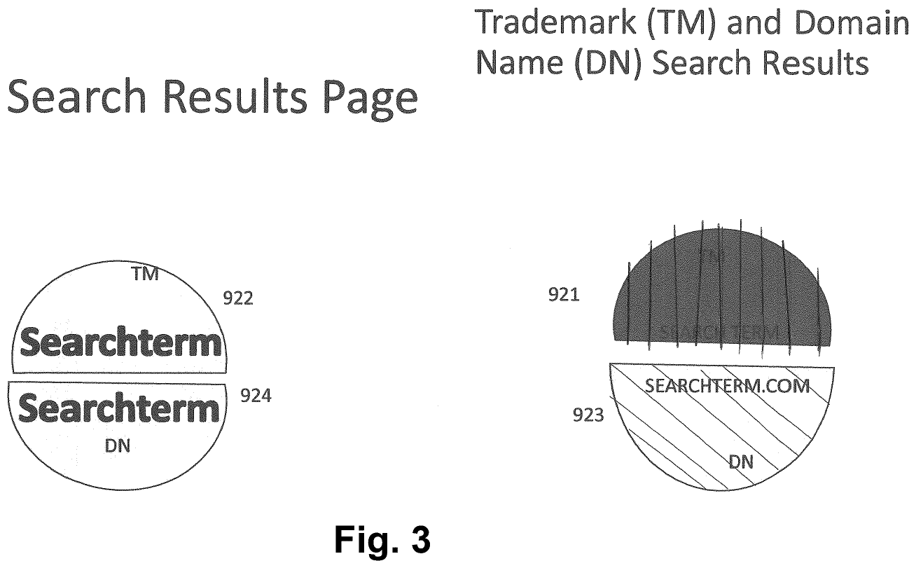

Turning to FIG. 3, an alternative for displaying search results is shown. The use of a circle as a graphic representation of the search results is desirable when the circle may be cut into pieces that are representative of the availability of a TM and/or DN. For example, following a search where it is determined that “searchterm” is available as a TM, upper circle half is displayed in green 922, and lower circle half is displayed in green 924, indicating that the DN is available. In another embodiment, the circle halves may be shaded red to indicate that the TM and DN are not available. In a further embodiment, if four search terms results are to be displayed, the circle may be sliced into four quadrants with a different color in each quadrant to represent “availability,” “likely available,” “feasible” and “not available.”

In a further embodiment, the search term results may be displayed as shown in FIG. 3 with cross-hatching designating availability or non-availability. So the vertical cross-hatching in circle half 921 indicates that “search term” is an available trademark and angled cross-hatching in circle half 923 indicates that “searchterm.com” is an available domain name. It is to be understood that different geometric shapes may be used and different colors or cross-hatching may be used.

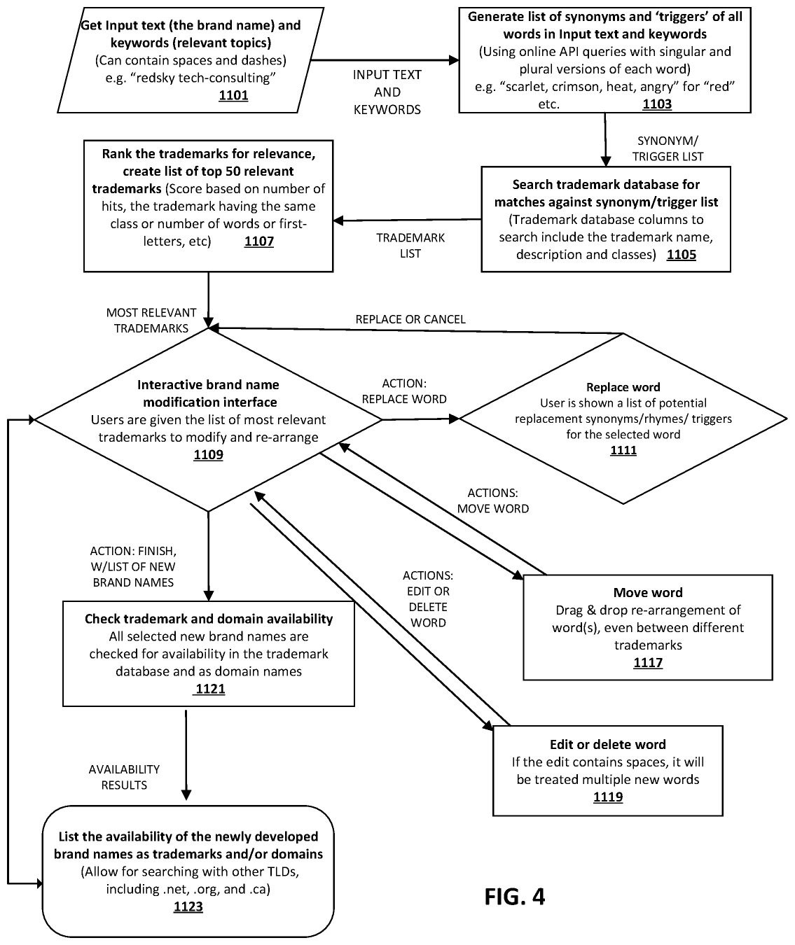

Turning to FIG. 4, an alternate embodiment of the invention is provided. At step 1101 a user inputs a first search term as text to the program including keywords to describe relevant topics. For example, where a database is being searched to determine whether a brand name is available the first search term is: “redsky tech-consulting.” The search term may include spaces, dashes or no spaces between words.

At step 1103, the program generates a list of synonyms and trigger words based on the first search term entered by the user's input of text and keywords. In an embodiment, the program may link with an Application Programming Interface (API) to generate synonyms or variations of the first search term. Also, singular and plural versions of each word/text is generated to form a trigger list. Trigger words are those whose presence raises the probabilities of certain other words appearing in the same sentence. For example, the trigger list may comprise: “scarlet, crimson, heat, angry, red, sky, tech, technology, consulting, technologies”.

Turning to step 1105, a database is searched using the first search term trigger list. For example, when searching against a trademark database to determine whether a trademark registration may be available for the first search term, the column's (categories) to be searched may include trademark name, service or goods description or classification. In an embodiment, each description and each classification may be input separately from trademark name (e.g. search term). A search engine will generate a first result list. The first result list, in an embodiment, will generate a list of trademarks/terms that are similar to the first term trigger list. In an alternate embodiment, the trademark database “live” and “dead” designations are used to determine availability. The “dead” designation will be used to identify search terms that are “available” and the “live” designation will be used to identify search terms that are “unavailable.” So for example, if the trademark database identifies a similar third party trademark as being terminated, abandoned, cancelled or expired, then the mark is “dead” and can be identified as “available” to a user to consider when establishing marks to register or variations to be promulgated by the program as a first (or second, third, fourth, etc.) result list.

At step 1107, the first result list is ranked by the program for relevance. For example, using the trademark database a score may be determined based on the number of hits generated between the trigger list and the database result. Fields include the trademark name and its description. Trademarks that have the same classification, same number of words, or the same first-letters as the first letter of words appear in the trigger list. In an embodiment, the top 50 trademarks by score are returned by the program and comprise the first search results.

At step 1109, a modification interface module is provided that provides tools for a user to modify the first search results. The modification tools may include a replacement module 1111, a re-arrangement module 1117 and an editing module 1119. For example, the replacement module 1111, using a database or application programming interface (API) provides a list of potential replacement words or synonyms, or rhyming words, or triggers for each of the words in the first search results. For example, the first search results may be: “scarlet sky consulting” and the word “sky” is replaced using thesaurus tool with “heaven,” so that the new trigger phrase (result) is “scarlet heaven consulting.” Thus, a new trigger term is a curated variation of the original first search term.

At step 1117, a re-arrangement tool may be used to move a word from the first search results by a user. In an embodiment, the words may be moved between different trademarks. For example, the tool 1117 may be used to modify “scarlet heaven consulting” to “heaven scarlet consulting.” Such re-arrangement may occur by dragging and dropping a word (e.g. moving “heaven.”) The new arrangement is then checked against the original trademark name to ensure that it has been changed. At step 1119, the editing module may be used by the user to edit or delete a word. For example, the user may delete “consulting” so that the new trigger phrase (term) is: “heaven scarlet.” It is understood that “heaven scarlet is a curated variation of the original search term “red sky.” In another embodiment, if the new trigger phrase contains spaces the new search program will search as multiple words. In a further embodiment, if there are no spaces (e.g. “heavenscarlet”) the trigger phrase will be searched as a single word.

At step 1121, the modified search result/trigger phrase is then searched again using a database search engine to look for similar trigger phrases or trademarks established by the iterative process of modification module 1109. For example, a trademark database may be searched against the trigger phrase to find similar trademarks. In another embodiment, a domain name database may be searched against the trigger phrase to see if a similar domain name is available.

Finally, at step 1123 the availability of the trigger phrase or modified search term is displayed for the user. For example, a brand name can be listed as “available” or “not available” based on a search of a data base for trademarks and/or domain names. When conducting the domain name search the search may be conducted for multiple suffixes (.net, .com, .org, .ca etc.). It is to be understood that by describing the preceding as an iterative process it includes mixing and rearranging any of the previous steps to arrive at new trigger phrases. For example, once step 1123 is complete, the user may take the search results and go back to step 1109 and modify the trigger phrase again to develop a new variation of the trigger phrase for subsequent searching. In this way it may be understood that the program generates a first search result that may be modified by a user with the modification interface to a form a first trigger phrase that undergoes a second search by the program that leads to a second trigger phrase prepared by the user at modification interface that undergoes a third search that leads to a third trigger phrase prepared by the user at modification interface that undergoes a fourth search, etc. Using such an iterative process, an interactive process is provided to develop search terms in a curated (by the user), yet automated (by the software program) fashion to develop variations of trigger phrases that may be used as second, third (and subsequent) search terms.

What is claimed is:

1. A system for conducting a search of a database comprising the steps of:
a user entering a first search term to the program;
dissecting by the program, the first search term into its component parts using a dictionary algorithm;
searching a first database using the first search term and saving a first result;
the user modifying the first result to form a second search term wherein the second search term includes at least one synonym from the first search term; and
conducting a second search using the second search term.

2. The system of claim 1, wherein the program includes a user modification interface to provide an iterative variation selection process.

3. The system of claim 2 wherein the user modification interface includes one of a replacement module, a re-arrangement module, an edit module and a deletion module for modification of the first result.

4. The system of claim 1, further comprising the step of using a thesaurus program to promulgate variations and ranking the variations.

5. The system of claim 1, wherein promulgation of variations is undertaken using Artificial Intelligence (AI).

6. The system of claim 5, wherein the AI is a ChatGPT program.

7. The system of claim 1 wherein ranking of the search term is undertaken by an expiration algorithm, wherein the incidence of expiring of a trademark term is calculated per classification and the ranking is higher for the fewest expiring trademarks per classification as determined by searching the database for expiring trademarks.

8. A non-transitory computer readable medium storing instructions that, when executed by one or more processors of a device controller, to cause the instructions to:
determine a variation of a search term corresponding to an initial search term; and the variation corresponding to the search term in meaning, category, rhyme or cadence.

9. The instructions of claim 8 wherein AI is used to locate a variant.

10. The instructions of claim 9 wherein ChatGPT is used to locate a variant.
